(19) United States
(12) Patent Application Publication
(10) Pub. No.: US 2004/0185325 A1
(43) Pub. Date: Sep. 23, 2004

(54) Fuel cell having improved catalytic layer

(76) Inventors: Peter M Faguy, Suwanee, GA (US); Clarke M Miller, Atlanta, GA (US); Andrew Tye Hunt, Atlanrta, GA (US); Jan Tzyy-Jiuan Hwang, Alpharetta, GA (US)

Correspondence Address: ALFRED H. MURATORI, MICROCOATING TECHNOLOGIES, INC., 5315 PEACHTREE INDUSTRIAL BLVD, ATLANTA, GA, 30341-2107, US

(21) Appl. No.: 10/416,593

(22) PCT Filed: Oct. 26, 2001
(86) PCT No.: PCT/US01/48581

(30) Foreign Application Priority Data
Oct. 27, 2000 (US) 60243966
Oct. 27, 2000 (US) 60243883

(51) Int. Cl. H01M 4/96; H01M 4/88; H01M 4/92

(52) U.S. Cl. 429/44; 502/101

(57) ABSTRACT

Catalytic layers for fuel cells are formed by co-depositing platinum or gold from a combustion chemical vapor deposition flame and carbon particles and ionomer from a non-flame, co-deposition flame. A layer having high platinum or gold loading with high particulate size is deposited. Such layers have high efficiency, whereby the total amount of platinum or gold used in a fuel cell may be reduced.

This invention was developed under National Science Foundation grants nos. DMI-9801444 and DMI-9960502; the U.S. government has rights in these invention pursuant thereto.

### BACKGROUND OF THE INVENTION

The present invention is directed to fuel cells having an improved catalytic layer for the cathode side and for the anode side of the cell.

A fuel cell or electrochemical cell that generates electrical power by virtue of an oxidation/reduction reaction through an electrolyte may be utilized to provide electrical power for various applications, and use of fuel cells to provide electrical power for many additional applications are anticipated as the cost of these cells is reduced. In a fuel cell, anode and cathode electrodes are disposed at opposite sides of an electrolyte, and reactive gases are introduced to the cathode and to the anode to generate the electrical power. A polymer electrolyte fuel cell (PEFC) or a solid PEFC is known. In the solid PEFC a solid polymer electrolyte layer with hydrogen ion (proton) conductivity is sandwiched between an anode side and a cathode side which each have a platinum (Pt)-containing catalytic layer and gas flow plates. The gas flow plates are disposed at opposite sides of the bonded assembly for supporting the assembly and are formed with grooves to which the reactive gas is supplied. With this structure, a fuel gas, e.g., hydrogen, is introduced to the anode side, and an oxidant gas, e.g., oxygen, is introduced to the cathode side to generate electrochemical energy.

In the solid PEFC, when an electrochemical reaction occurs, hydrogen is oxidized and oxygen is reduced, and an electrical current is generated between the electrodes while water is produced as by-product in the cathode. The operative temperature of the solid polymer electrolyte fuel cell is as low as about 60° C. Thus, the polymer electrolyte fuel cell is suitable for use as a portable power source. Particularly, it is contemplated that stacked PEFCs be used as a power source for electric automobiles. In this regard, it should be noted that the automobile requires a supply source of the hydrogen gas as a fuel gas. The source may be a portable hydrogen tank, a reformer, or the like. On the other hand, ambient air is used as the oxidant gas by reason of weight, cost of the system, and the like. Because air is only 20% oxygen, performance decreases because of the reduction in reaction rate and mass transport during the combined reaction in the fuel cell.

To enhance efficiency, air is generally compressed for introduction into the fuel cell. The compressor reduces energy efficiency in the fuel cell as a whole because a certain amount of energy is expended in driving the air compressor.

Various ways have been proposed to enhanced energy efficiency of a fuel cell under a low partial pressure of oxygen.

For example, it has been known that an electrocatalyst substance (usually platinum that is active for the reduction reaction under a low temperature condition as low as 80° C. or even as low as 60° C.) is employed in the form of finely divided particulates to improve the electrocatalytic activity and that the electrocatalyst substance is supported by a corrosion resistant carbon to improve catalyst contact with the gases. It is further known to use an ionomer, such as a sulfonated perfluoro ether, e.g., that sold as Nafion®, as an ionically conductive binder for the carbon and platinum.

A serious limitation to the use of fuel cells, e.g., for general automotive use, is their high cost, a substantial portion of this cost being the platinum used in the catalytic layers. The cost of fuel cells could be significantly reduced if platinum could be used more efficiently and therefore in smaller quantities. Gold is an alternative catalyst, and similar cost/efficiency concerns are true if gold is used.

Heretofore, catalytic layers for cathodes have been produced from solutions of the polymeric binder containing suspended particulates of carbon and platinum. Catalytic layers for the anode typically also contain ruthenium in addition to platinum, the ruthenium being in metal and/or oxide form or alloyed to the platinum. Alternatively, catalytic layer materials have been produced by sputtering. U.S. Pat. No. 6,106,965, the teachings of which are incorporated herein by reference, describe a catalytic layer formed from a solution and having a platinum-carbon layer sputtered onto the surface that is bonded to the proton diffusion layer.

The platinum loading achievable by such prior art techniques is relatively low, requiring such layers to be thicker than might be desired in order to obtain the requisite catalytic activity. The thicker the layer, the less efficiently the layer, and thus the fuel cell as a whole, operates. Generally the highest concentration of platinum at small particulate size, i.e., a reported mean particle size of 1-5 nanometers, e.g., 3 nanometers or less, achievable by prior art methods is about 20 wt %.

The present invention is directed to production of catalytic layer material that achieve substantially higher catalyst concentrations while maintaining small particulate size than are achievable by prior art fabrication techniques. This allows for substantially thinner layers that significantly more efficiently use the catalyst. Thus, even though the layer material has higher concentrations of small particulate size catalyst, e.g., platinum or gold, as a weight percentage of layer material, the total amount of catalyst used in the layer is reduced due to reduced layer thickness.

### SUMMARY OF THE INVENTION

In accordance with the present invention, a catalytic layer for a fuel cell is deposited on a substrate that may be either the proton diffusion layer of a fuel cell or the cathode itself, e.g., the carbon cloth of the cathode, by a modified combustion chemical vapor deposition (CCVD) process. Catalytic particulates, generally platinum for the cathode (or platinum/ruthenium for the anode), but also other catalytic metals, such as gold, are deposited from vapors produced in a flame or flames that burn a precursor solution containing a chemical precursor for the catalytic material(s). Finely divided particles of carbon and dissolved ionomer, e.g., Nafion®, are co-deposited from an atomized solution/suspension such that the flame-formed catalytic particulates, the carbon particulates, and ionomer are integrally mixed as a deposited catalytic, ionically conducting layer. Catalytic material concentrations are substantially higher than are achievable by prior art deposition methods. The primary catalyst, particularly platinum, but also gold, at particulate concentrations of 30%, 40%, 50% and even 60% (by weight of deposited layer material) and upward are achieved with particulates of 5 nanometers or less mean particulate size or even 3 nanometers or less mean particulate size. In forming the anode layer, ruthenium is also co-deposited, the ruthenium existing as a metal and/or as an oxide or alloyed with the metal. Dramatic improvements in efficiency are achieved by these high primary catalyst loading levels, particularly at levels of 40 wt. % or above with mean catalytic particulate sizes of 5 nanometers or less or even 3 nanometers or less.

In accordance with one aspect of the invention, a catalytic layer is produced with a gradient of catalytic particulates with a lower catalytic particulate level adjacent the electrode (cathode or anode) and increasing catalytic particulate levels toward the proton diffusion layer. The contacting surface with the proton diffusion layer is a zone of about 100-200 nanometers thickness that contains a catalytic layer.

A hydrophobic polymer, particularly polytetrafluoroethylene (PTFE), such as that sold as Teflon®, may be suspended in the ionomer/carbon solution/suspension to assist in water management within the fuel cell. In a gradient catalytic layer, it may be desired to have a higher level of PTFE toward the electrode (cathode or anode) and a lower level of PTFE toward the proton diffusion layer. Other hydrophobic particulates, such as functionalized silica, may be used in place of PTFE.

### BRIEF DESCRIPTION OF THE DRAWINGS

FIG. 1 is a schematic cross-sectional view of a proton exchange layer fuel cell that utilizes a catalytic layer or catalytic layers in accordance with the invention.

FIG. 2a is a schematic cross-sectional view of a cathode catalytic layer in accordance with the invention that has increased catalytic particulate levels toward the proton diffusion layer and increased polymer level toward the cathode.

FIG. 2b is a schematic cross-sectional view of an anode catalytic layer in accordance with the invention that has increased catalytic particulate levels toward the proton diffusion layer and increased polymer level toward the anode.

FIG. 3 is a diagrammatic illustration of a deposition arrangement for depositing the catalytic layers.

FIG. 4 is a diagrammatic illustration of another deposition arrangement for depositing the catalytic layers.

### DETAILED DESCRIPTION OF CERTAIN PREFERRED EMBODIMENTS

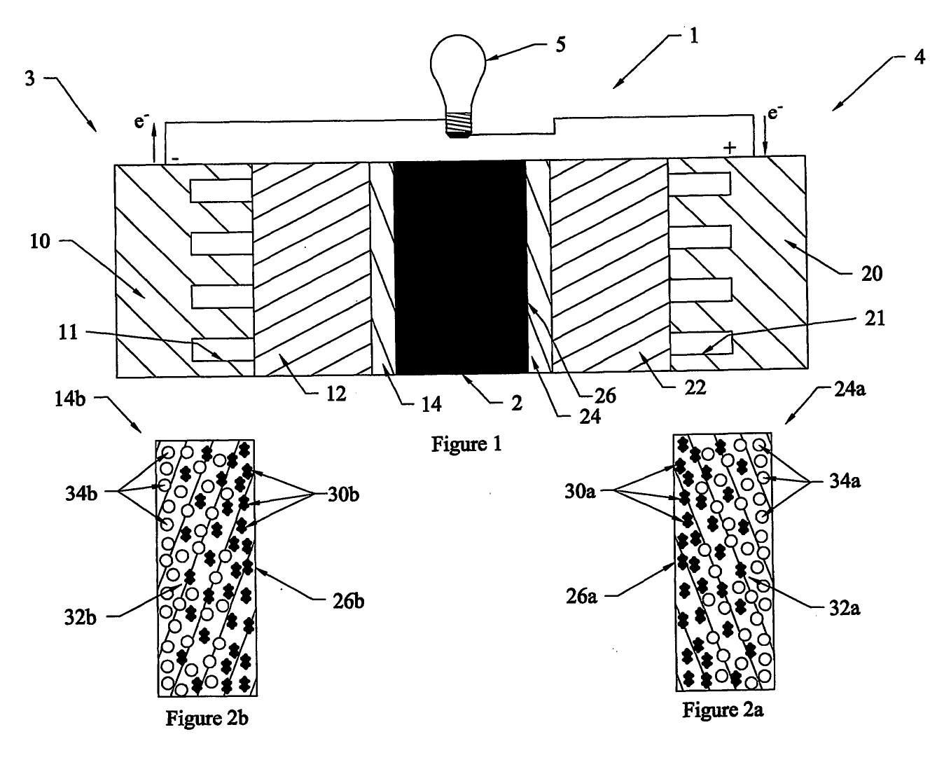

The illustrated fuel cell (1) in FIG. 1 is provided with a solid polymer, proton diffusion, electrolyte layer (2) in the middle, an oxidation or anode electrode (3) at one side thereof to which a hydrogen as a fuel gas is supplied and a reduction or cathode electrode (4) at the other side to which an oxygen source, such as air, is supplied.

With respect to FIG. 1, on the left-hand (anode electrode (3)) side is a gas flow plate (10) having grooves (11) that separates gas and collects gas generated. The gas flow plate (10) may be formed of conductive material, such as stainless steel or graphite, and machined to form the grooves. Bonded to the gas flow plate (10) is a carbon cloth (12). Inward of this is an anode catalyst layer (14) in accordance with the invention into which hydrogen gas diffuses and is oxidized to form the protons that diffuse through the proton exchange layer (2) toward the cathode (4) side.

The cathode electrode structure (4) is similar to the anode electrode (3) structure, having from right-to-left with respect to FIG. 1 a gas flow plate (20) having gas-conducting grooves (21), a bonded carbon cloth (22), and a catalytic layer (24) according to the present invention into which oxygen gas diffuses and receives protons from the layer (2) to reduce the oxygen and thereby form water. In place of the carbon cloth could be a carbon fiber array or non-woven material.

Protons (H⁺ ions) are generated in the anode (3) side of the cell and migrate from the anode side to the cathode (4) side through the electrolyte layer (2). Electron generated in the anode electrode (3) perform external work in a load (5), and the electrons then return to the cathode electrode (4) of the fuel cell (1). In the anode electrode (3), the protons (H⁺) are produced by removing the electrons from hydrogen molecules. In the cathode electrode 4 are the protons (H⁺ ions) that have passed through the layer (2), along with the oxygen gas supplied from the cathode gas, and the electrons received from the anode produce water molecules.

It is to improvement of the anode catalytic layer (14) and improvement of the cathode catalytic layer (24) that the present invention is primarily directed. By deposition methods in accordance with the present invention, high concentrations of very small catalytic particulates may be achieved in all or a portion of the layer (14) or (24). The catalytic electrode material of the present invention has, at least at its proton diffusion layer-facing surface (26), a catalytic particulate content significantly above that achievable by prior art fabrication procedures, i.e., the primary catalyst, such as platinum or gold, is present at mean particulate sizes of 1-5 nanometers, e.g., 3 nanometers, at least about 30 wt % (based on total weight of catalytic material, carbon, and polymer), preferably at least about 40 wt %. Within the present invention, quality functionality occurs even at about 60 wt %. Amounts above 80 wt %, however, result in layers having diminished performance and shortened life spans. For the cathode layer (24), the catalytic material is preferably platinum, but may be gold as well. For the anode layer (14), the catalytic material is generally a mixture of platinum and ruthenium with the ruthenium being in metallic and/or oxide form or the ruthenium may be alloyed with the platinum.

As illustrated in FIG. 2a with respect to a specific embodiment of a cathode layer (24a), for high power output fuel cells, such as might be required in future automotive applications, the catalytic layer (24a) may be produced with a gradient of catalyst/carbon, represented as irregular solid, particulates (30a) contained in an ionomer binder (32a), represented as cross-hatching, with the highest catalyst/carbon levels adjacent the proton diffusion layer-facing surface (26a) and lower levels of catalytic particulates away from the layer-facing surface. This is because reduction of the oxygen is more efficient toward the proton diffusion layer (2). Because water is produced on the cathode side of the cell, efficient water management may be promoted by inclusion of PTFE in the layer (24) or (24a), and impregnation of the carbon cloth (22) with PTFE. In a gradient layer (24a), the PTFE particulates (represented as clear particulates (34a)) may be deposited in higher concentrations toward the cathode (4), and lower concentrations toward the proton-diffusion layer (2). In other cases different PTFE distributions may be desired, although it is most common for PTFE to be uniformly distributed throughout. In place of PTFE particulates, other hydrophobic particulates, such as functionalized silica, may be used for water management.

The preferred method of deposition of either a cathode layer (24) or an anode layer (14) is a modified combustion chemical vapor deposition (CCVD) deposition process. CCVD is described, for example, in U.S. Pat. No. 5,652,012, the teachings of which are incorporated herein by reference. CCVD deposition of platinum is specifically described, for example, in U.S. patent application Ser. No. 09/069,679 filed 29 Apr. 1998, the teachings of which are incorporated herein by reference.

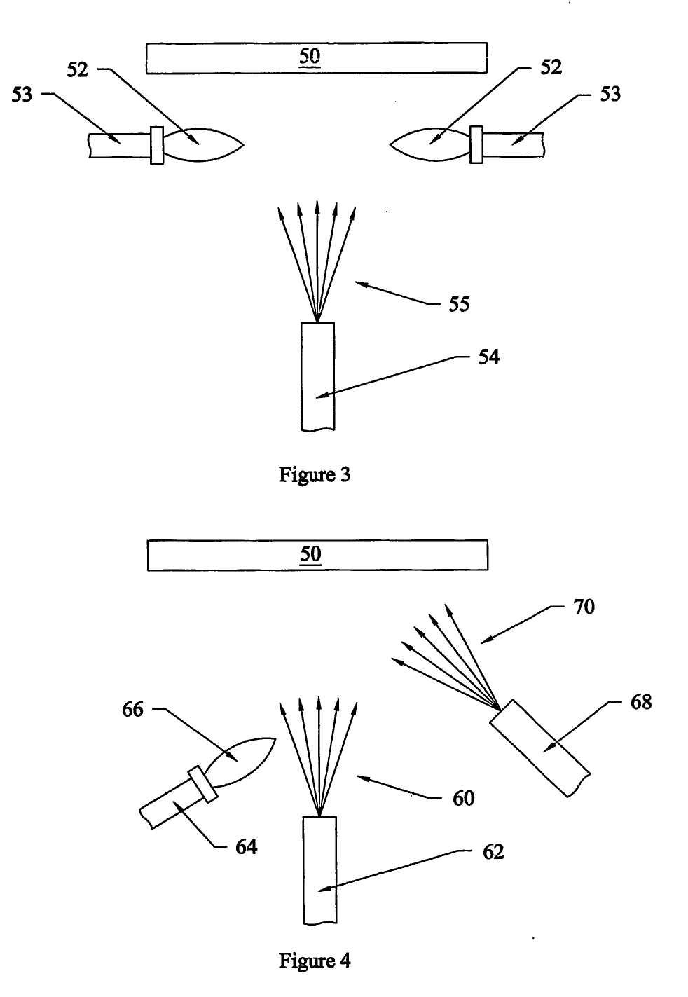

With reference to FIG. 3, there is provided a deposition substrate (50). The deposition substrate (50) may be either the carbon cloth (22) of the cathode or the carbon cloth (12) of the anode or the proton diffusion layer (2). Alternatively, the substrate (50) may be a layer of material from which the deposited layer (24) is transferred after formation to either the carbon cloth or the proton diffusion layer.

Shown in FIG. 3 are two CCVD flames (52) from CCVD nozzles (53). These are shown producing flames in a direction parallel to the surface of the substrate 50. The flames are each produced by burning, in open atmosphere, a finely atomized solution of a fuel and a dissolved catalytic material precursor chemical(s), such as platinum acetylacetenoate (Pt AcAc), gold acetylacetenoate (Au AcAc), and Ruthenium acetylacetenoate (Ru AcAc). By adjusting the concentration of the platinum precursor chemical and the size of the droplets in the aerosol, as is known in the art, the platinum particulate domains may be varied over a broad mean particulate size range. Preferably, the platinum particulates are in the range of mean particulate size of between about 1 and about 5 microns in diameter, more preferably 2 and about 3 nanometers in diameter. The small particulate size of the Pt domains provides a high surface area to Pt weight (as measured, for example, in m²/gm). At particulate sizes below about 2 nM, layers containing such particulates become less stable, and long term performance may deteriorate significantly.

Also, illustrated in FIG. 3, is a nozzle (54) that produces a non-flame spray (55) of a solution/suspension containing dissolved ionomer, suspended carbon particulates, and (optionally) suspended particulates of PTFE. The mean particle size of the carbon particulates ranges from about 10 nanometers to about 40 nanometers. The mean particle size of the PTFE particulates (if used) also ranges from about 10 to about 40 nanometers. As it is desired that the polymer component(s) not burn, it is preferred that the solvent system for the re-direct, dissolved ionomer solution contain a substantial portion of water, i.e., at least about 50 wt % of the solvent system is preferably water.

The spray (55) from nozzle (54) is directed through the vapor region between the two flames (52), whereby the platinum particulate-containing, flame-produced vapor is redirected in a direction toward the substrate (50). In this manner, carbon, platinum and/or gold, ionomer, and (optionally) PTFE particulates are co-deposited on the substrate. The relative amounts of the carbon, ionomer and PTFE are controlled by their relative concentrations in the non-flame spray solution/suspension. The amount of Pt and/or Au is controlled by the amount of Pt and/or precursor fed to the spray, as determined by the Pt and/or Au precursor chemical concentration in the flame-producing solution and the feed rate of this solution.

Both the flame spray and the non-flame spray(s) could be directed at the substrate to co-deposit platinum, carbon and polymer; however, to reduce the deposition temperature at the flame surface, it is preferred that the flame or flames be directed at an angle oblique to the substrate surface and that the non-flame spray be used to re-direct the platinum-containing vapor produced by the flame toward the substrate surface. The preferred angel of the flames to the surface is parallel to the surface as illustrated in FIG. 3. Generally, it is desirable that the deposition temperature at the surface be 180° C. or below. An important aspect of the re-direct deposition illustrated is that the spray rapidly quenches the flame-produced vapor.

The deposition of the catalytic layer (24) (or (24a)) of the present invention can be on the electrode or, preferably, is directly on the proton-diffusion layer (2). It is found particularly that when deposition of the layer (24) is directly on the proton-diffusion layer (2), faster break-in times result.

Because the carbon provides an electrical path and because some carbon particulates support Pt and/or Au particulates for catalytic activity, the Pt:C or Au:C weight ratio is generally between about 5:1 and about 2:1, preferably between about 3:1 and about 2:1. Even when a Pt gradient layer (24a) is produced, as per FIG. 2, the Pt:C and/or Au:C weight ratio is generally kept the same or within a range of 5:1 and 1:5

In the anode layer (14), ruthenium form is co-deposited with the primary catalyst. The ruthenium deposits as a metal and/or as an oxide or becomes alloyed with the metal. As in prior art anode layers of this type, the molar ratio of Pt:Ru may be in the range of 1:1; however, the deposition method of the present invention enables Pt:Ru molar ratios to vary from 100:0 to 0:100, typically from 90:10 to 10:90. It is found that the molar ratio of Pt to Ru which is supplied in the flame-producing precursor solution is very closely exhibited in the layer that is deposited. This has particular advantage in being able to fine tune the Pt:Ru molar ratio by a series of depositions, first to roughly find an optimal ratio, then to finely tune the optimal molar ratio for a particular fuel cell layer.

In accordance with another aspect of the invention, it is found that by using the deposition method of the present invention, the level of carbon particulates in the anode layer may be reduced or even eliminated. That is, the Pt:C weight ratio can be reduced to about 6:1 or below, even down to 0. Even without carbon, high Pt concentrations are desired; however, this feature is considered unique and novel even at low Pt levels, e.g., down to about 10 wt % based on total layer material.

Illustrated in FIG. 2b is an alternative embodiment of an anode catalytic layer (14b) in accordance with the invention. The Pt/Ru or Pt/Ru/C particulates, represented as solid particulates (30b), are more concentrated in the surface portion (26b) that contacts the proton conduction layer 2 and less concentrated toward the anode. If PTFE particulates are incorporated, represented as clear particulates (34b) within the ionomer matrix (32b), the PTFE is less concentrated more concentrated toward the anode carbon cloth (12) and less concentrated toward the proton diffusion membrane (2). In such electrodes, the Pt:Ru:C ratio is generally about the same throughout.

If a layer of uniform composition throughout is desired for either the cathode layer or the anode layer, a single flame-producing solution and a single spray solution may be used. If it is intended that the Pt concentration be a gradient from one side of the layer, an appropriate gradient pump may be used to admix a solution that contains platinum precursor chemical with varying amounts of additional solvent. If a PTFE gradient is to be produced, two non-flame spray solutions may be admixed with an appropriate gradient pump, one containing higher levels of suspended PTFE particulates, one containing lower levels of suspended PTFE particulates. Catalytic layers of the present invention, at least at the portion which contacts the proton diffusion membrane (2), have an organic component that ranges from 80 wt % to 100 wt % ionomer, 0 wt % to 20 wt % hydrophobic polymer that is preferably PTFE.

Catalytic layers in accordance with the invention range from about 0.1 to about 10 microns in thickness, preferably from about 0.3 to about 8 microns in thickness. The thinness of the catalytic layers in accordance with the invention promotes gas-diffusion through the layers without significant porosity and gas permeability in at least a significant portion, e.g., the half, of the layer adjacent to the ionomer layer.

Illustrated in FIG. 4 is an alternative deposition set-up for depositing the catalytic layer of the present invention on a substrate (50). Carbon particulates are suspended in a medium, such as an aqueous medium, and a spray (60) is directed at the substrate (50) from a nozzle (62) located at an outer location. Disposed at an angle toward the spray (60), also at an outer location, is a nozzle (64), from which emanates a platinum particulate-producing flame (66). This flame (66) is directed at an angle to the spray (60) such that the flame-produced platinum particulates become associated with the carbon particulates. Downstream of nozzles (62) and (64) is an additional nozzle (68) that produces a spray (70) of ionomer. Ionomer nozzle (68) is likewise directed an angle to the carbon spray to intermix with the platinum/carbon agglomerates. This arrangement may result in improved platinum/carbon catalytic interaction.

As an alternative to depositing a layer, the material may be deposited as a powder for forming into a layer by known powder processing techniques. In such case, the flame(s) and spray(s) will co-deposit material as described above; however, instead of disposing a substrate in the path of the flame(s) and spray(s), the deposition is into a vacant area where the material will lose solvent and form powders. Energy may be provided to this region to help flash off solvent.

For some purposes, it is desirable to deposit as an anode layer only a layer of platinum and ruthenium. Again ruthenium may be in the metallic, oxide, or mixed metallic and oxide states. To make such a deposition, only a flame is required, without a co-deposition flame. The relative amounts of metallic to oxidized ruthenium may depend upon the amount of oxygen relative to combustible components supplied to the flame. For this purpose, the Pt:Ru weight ratio ranges from 90:10 to 10:90, preferably 60:40 to 40:60. This material can also be deposited as a powder, e.g. by not having a deposition surface proximal to the flame. The powder can then be used to form a catalytic layer by conventional means.

The invention will now be described in greater detail by way of specific examples.

### EXAMPLE 1

### Cathode Layer

In a 75/25 vol./vol. Solvent system of water and isopropyl alcohol is dissolved 0.0125% by weight Naflon and is dispersed 0.05 wt % carbon particles of mean particle size of 22 nanometers. A flame-producing solution is formed by dissolving PtAcAc at 0.02 molar in a 95/5 vol./vol. Toluene/dimethyl formamide solvent system. The flame solution is supplied to form two opposed flames from nozzles 9.6 cm. apart and 7 cm. from the substrate surface, each directed parallel to the substrate surface. The non-flame solution/dispersion is sprayed from a re-direct nozzle in accordance with the set-up of FIG. 2. The non-flame nozzle is disposed 12 cm. from the substrate surface. Solution flows through the nozzle at 9 ml/min with a nitrogen flow rate of 25 liters per min at 36 psi.

A layer 3.5 microns thick is deposited at deposition times of between 9 and 10 seconds per cm², the resulting composition being 60 wt % Pt, 22 wt % C, and 18 wt % Nafion®. Platinum loading was 0.4 mg/cm².

The deposited layer was substituted for a prior art layer in a H₂/O₂, single stack, layer electrode assembly (MEA) fuel cell. With the layer of the present invention 635 millivolts at 1 amp per cm was produced. Operation was at 80° C. with pressurized gases. The MEA resistance was below 8 megaohms/cm², and the MEA achieved steady-state operation of 1.2 Amps/cm² at 500 mV after 5 hours of break-in operation. The test was for cathode performance with the performance limitation at the cathode.

### EXAMPLE 2

### Anode Layer

1100 MW soluble Nafion® was dissolved at 0.025 wt % in a 25/75 water/isopropyl alcohol (v/v) solvent system to form a re-direct spray solution. In a toluene-based solvent system containing 5 wt % dimethyl formamide (DMF) and 20 wt % acetone was dissolved 0.0084 molar platinum acetylacetenoate and 0.0716 molar ruthenium acetylacetenoate. The flame solution was supplied to form two opposed flames from nozzles 9.6 cm. apart and 7 cm. from the substrate surface, each directed parallel to the substrate surface. The flame conditions are a solution flow of 3 ml/min through each nozzle, a substrate surface temperature of 175-185° C., pump pressures of 166 and 54 psi, oxygen flow rates of 12 and 11 psi in the pumps, oxygen flow of 6000 ml/min, and Variac settings of 3.5 amps for each flame nozzle. The non-flame solution /dispersion is sprayed from a re-direct nozzle in accordance with the set-up of FIG. 3. The non-flame nozzle is disposed 12 cm. from the substrate surface. Solution flows through the spray nozzle at 9 ml/min with a nitrogen flow rate of 25 liters per min. at 36 psi. Deposition proceeds for 15 seconds per unit area depositing a layer.

The loading was 0.12 mg/cm²; 0.7 mg/cm² Ru. Layer is about 60% catalyst. The fuel cell performance on air/reformate 550 mv at 1 A/cm² 80° C., 4% air bleed at anode feed, 40 ppm CO in simulated reformate. Test was for anode performance in which performance is limited by anode.

Platinum comprises 38 wt % of the layer.

### EXAMPLE 3

### Anode Layer

A solution was prepared of 0.01 M PtAcAc and 0.01 RuAcAc in a toluene-based solution containing 20% by volume acetone and 5% by volume DMF. This solution was sprayed through two flame nozzles in accordance with the set-up of FIG. 3 and re-direction spray consisted of a 25/75 v/v water/isopropyl alcohol solution. Deposition was 16 sec per unit area, flow through the flame nozzles at 3 ml/min, at pressures of 900-950 psi, oxygen flow of 6000 ml/min and Variac settings of 3.5 amperes. A Pt/Ru coating was produced with a 2.7 to 1 Pt/Ru molar ratio. Pt and Ru (and/or ruthenium oxide) were homogeneously distributed in particulates 2 nanometers or less particle size.

Platinum comprises 50 wt % of the catalytic layer.

What is claimed is:

1. A catalytic layer suitable for use in a fuel cell, said catalytic layer contacting a proton diffusion layer of the fuel cell, at least said proton diffusion layer-contacting surface portion of said layer being a material comprising,
at least about 30 wt % platinum or gold particulates of mean particulate size of 5 nanometers or less, carbon particulates at a Pt:C or Au:C weight ratio of between about 5:1 and about 2:1, balance organic material, said organic material comprising between about 80 wt % and 100 wt % gas permeable ionomer and from 0 wt % to about 20 wt % particulates of hydrophobic polymer.

2. The catalytic layer of claim 1 wherein at least said proton diffusion layer-contacting surface portion of said layer is formed of material having at least about 40 wt % platinum or gold particulates of mean particle size of 5 nanometers or less, at least at said proton diffusion layer-contacting surface portion.

3. The catalytic layer of claim 1 wherein said platinum or gold particulates have mean particulate sizes of 3 nanometers or less.

4. The catalytic layer of claim 2 wherein said platinum or gold particulates have mean particulate sizes of 3 nanometers or less.

5. The catalytic layer of claim 1 wherein the Pt:C or Au:C weight ration is between about 3:1 and about 2:1.

6. The catalytic layer of claim 1 containing not more than about 80 wt % particulates of Pt or Au.

7. The catalytic layer of claim 1 wherein at least a portion of said layer is effectively gas impermeable.

8. The catalytic layer of claim 1 wherein said layer is predominantly gas impermeable.

9. The catalytic layer of claim 1 having a uniform composition throughout.

10. The catalytic layer of claim 1 having a highest Pt or Au concentration at a proton diffusion layer-contacting surface portion and a gradient of lower Pt or Au concentrations away from said proton diffusion layer-contacting surface portion.

11. The catalytic layer of claim 1 bonded to a proton diffusion layer.

12. The catalytic layer of claim 1 bonded to a cathode.

13. A fuel cell comprising an anode, an anodic catalytic layer, a proton diffusion layer, the catalytic layer of claim 1 as the catalytic layer and a cathode.

14. A method of forming a catalytic layer comprising, providing a combustion chemical vapor deposition flame that produces platinum or gold particulates, providing a non-flame spray or sprays, said non-flame spray comprising a solvent system, dissolved ionomer, and suspended carbon particulates, and causing said non-flame spray or sprays and platinum or gold particulates produced by said flame to co-deposit on a substrate surface.

15. A catalyst layer suitable for use in conjunction with an anode in a fuel cell formed of material, said catalyst layer having a surface portion for contacting a proton conduction layer, said material comprising at least about 30 wt % platinum particulates of mean particle size of 5 nanometers or less at at least said proton conduction layer-contacting portion, co-deposited ruthenium in metallic and/or oxide form or alloyed with the platinum, and an ionomer.

16. The catalyst layer according to claim 15 wherein said particulates have a mean particulate size of 3 nanometers or less.

17. The catalyst layer of claim 15 having at least about 40 wt % platinum particulates of mean particle size of 5 nanometers or less, at least at said proton conduction layer-contacting surface portion.

18. The catalyst layer of claim 17 wherein said particulates have a mean particulate size of 3 nanometers or less.

19. The catalyst layer of claim 11 bonded to a proton conduction layer.

20. The catalyst layer of claim 11 bonded to an anode.

21. A fuel cell comprising an anode; the catalyst layer of claim 11 as the anodic catalyst layer; a proton conduction layer; a cathodic catalyst layer; and a cathode.

22. A method of forming an anode catalytic layer comprising, providing a combustion chemical vapor deposition flame that produces platinum particulates and which co-deposits ruthenium in metallic and/or oxide form or alloyed to the platinum,
providing a non-flame spray comprising a solvent system and dissolved ionomer, and
causing said non-flame spray, and platinum particulates along with said co-deposited ruthenium, in metallic and/or oxide form or alloyed with the platinum, produced by said flame to co-deposit on a substrate surface.

23. A catalytic layer comprising platinum particulates, ruthenium in metallic and/or oxidized form, gas permeable ionomer, and carbon particulates at a Pt/C weight ratio of about 6:1 or less down to 0 carbon particulates.

24. The catalytic layer according to claim 23 having no carbon particulates.

25. Catalytic material comprising at least about 30 wt % platinum particulates of mean particle size of 3 nanometers or less, co-deposited ruthenium in metallic and/or oxide form or alloyed with the platinum, and a gas ionomer.

26. The material of claim 23 in powder form.

27. The material of claim 26 in wet or dry form.
